(19) United States
(12) Patent Application Publication
(10) Pub. No.: US 2002/0083042 A1
(43) Pub. Date: Jun. 27, 2002

(54) Data management method

(75) Inventor: Michiyo Sasoh, Natori (JP)

Correspondence Address: JORDAN AND HAMBURG LLP, 122 EAST 42ND STREET, SUITE 4000, NEW YORK, NY, 10168, US

(73) Assignee: AT SYSTEM CO., LTD, Natori (JP)

(21) Appl. No.: 10/004,008

(22) Filed: Nov. 2, 2001

(30) Foreign Application Priority Data
Nov. 2, 2000 (JP) 2000-336672
Jul. 16, 2001 (JP) 2001-215831

(51) Int. Cl. G06F 7/00

(52) U.S. Cl. 707/1

(57) ABSTRACT

The present invention provides a system and method for simply creating tables required to build a database via a communication network without requiring advanced knowledge or skills. After receiving a prescribed table file and converting it, if necessary, into text format, the server extracts table information from this table file in accordance with prescribed rules, makes judgements, and memorizes the information. This enables table information required for creating a database to be automatically generated in the server, and thus a database can be simply built.

### BACKGROUND OF THE INVENTION

1. Field of the Invention

The present invention relates to a data management method and data management system, in particular to a method of building a database in a remote computer via a communication network and a system for building a database.

2. Description of the Related Art

There are conventional database systems that manage large amounts of information comprising numbers, letters, etc. They are widely used to search for information with prescribed elements from large amounts of data. With the recent development of the Internet, it has become possible to use so-called Web browsers to acquire information of every genre from computers all over the world. For example, a database can be linked to a web page read via the Internet. Readers who access this web page can obtain the data they desire from within the database by implementing a search in the web page.

The database usually first defines a table to suit a database design then creates a procedure for inputting the above information into the defined table. The defining a table involves the following. Firstly, a decision is made relating to the table configuration for all data types that will be stored in the database. In other words, a decision is made as to whether to configure the database as one table or to divide it up into a multiplicity of tables based on the character, importance, duplicity of each data, and on data-access and update frequencies. Next, the item names for stored data, and data types and sizes are defined for each table that will be used in the configuration. User access permission is specified on each table.

In order to create a database it is necessary to define a table to suit the contents of the database. However, to build a database using this table definition and the defined table requires knowledge relating to the specification of types and sizes of data to be input, knowledge regarding database construction, and advanced skills such as programming skills are required. Therefore, in almost all cases, the building of a database requires a specialist programmer to be contracted to the job and the cost of this is generally high. Also, when database items are to be added or to be deleted from a database in a computer, the table must be redefined and again, a specialist programmer is normally required for the implementation. Therefore, it has not been possible to easily add or delete database items once a database has been constructed.

Also, as discussed above, when a new database is to be built in a computer, tables are defined to suit the database design. Here, the above computer has had to be directly operated without the use of dedicated lines, or after remote log-on via the Internet or a dedicated line. Therefore, users of rental servers have had no way of defining tables and building a new database without directly operating a computer at a remote location. Also, when updating data in a database built in a remote computer, data has only been able to be replaced by remote log-on. Here too, programs written by specialist programmers are normally required.

To read or search data that has been stored in a database thus built from a Web browser on a remote terminal, it is necessary to link the database and the web page. To link these also requires knowledge of database construction, knowledge about creating web pages, and advanced skills such as programming skills. Therefore, linking databases and web pages has almost always required a specialist programmer and the cost of this is generally high.

Therefore, a method that can be used by the operator of a user terminal, without special knowledge or skills, to define the tables required when building a database in a computer that is located away from the user terminal, and a method and system for building a database using those tables have been sought. Also sought has been a method and system that enables data in a database built in a computer apart from a user terminal to be read or searched via a communication network such as the Internet.

### SUMMARY OF THE INVENTION

An object of the present invention is to provide a method and system for the simple creation of the tables required to build a database from a remote location via a communication network without the need for the advanced knowledge or skills described above.

A further object of the present invention is to provide a method and system that enables one to create, update, and modify a database using the above table.

A still further object of the present invention is to provide a method and system that enables a created database to be simply utilized onto a web page from a remote location via a communication network without the need for advanced knowledge or skills.

The present invention provides a method of managing data in a server that can communicate via a communication network with a user terminal that has a Web browser, wherein the above-mentioned server comprises: a reception process that receives table files containing data required for defining at least item names and data types corresponding to the above-mentioned item names from a user terminal via a communication network; a table file judgement process that judges whether or not the above-mentioned received table file is a table text file in text format in which each data is delimited with delimiter symbols or delimiter characters; a table file conversion process that converts the above-mentioned table file into table text file when the above-mentioned table file is judged not to be the above-mentioned table text file in the above-mentioned table file judgement process; table information determination process that extracts, from the above-mentioned table text file, data required for defining at least item names and data types corresponding to the above-mentioned item names in accordance with the above-mentioned delimiter symbols or delimiter characters, and that determines data including at least item names and data types corresponding to the above-mentioned item names; and a table information storage process that stores the above-mentioned table information in association with at least item names and data types corresponding to the above-mentioned item names.

Use of the above data management method of the present invention enables the server to receive a table file containing the data needed to define at least item names and the data type corresponding to those item names from a user terminal and to convert this table file into a table text file if required. The server then distinguishes which information includes the item names and data types from the table text file and stores the table information. Therefore, the operator of a user terminal can easily define the tables required for the building of a database in a server apart from the user terminal by merely sending the prescribed table file via a communication network. In the same way, the [operator of a user terminal] can also easily update and change table information when a database is to be updated or modified.

Also, in the data management method of the present invention, the server may further comprise: a data file judgement process that judges whether the above-mentioned table text file contains data to be accumulated in database and is a table text file in text format, in which the above-mentioned data is delimited with delimiter symbols or delimiter characters; and a database accumulation process that, when the above-mentioned file is judged to be the above-mentioned data text file in the above-mentioned data file judgement process, extracts the above-mentioned data to be accumulated in database stored in the above-mentioned data text file in accordance with the above-mentioned delimiter symbols or delimiter characters, and accumulates the extracted data in the database in accordance with the above-mentioned table information stored in the above-mentioned table information storage process.

In the data management method of the present invention, the server may further comprise: a second reception process that receives a data file that contains data to be accumulated in database from a user terminal via a communication network; a second data file judgement process that judges whether the above-mentioned data file received is a data text file in text format in which data delimited with delimiter symbols or delimiter characters; a data file conversion process that converts the above-mentioned data file into data text file when the above-mentioned data file is judged not to be the above-mentioned data text file in the above-mentioned second data file judgement process; a data compatibility judgement process that extracts the above-mentioned data to be accumulated in database stored in the above-mentioned data text file in accordance with the above-mentioned delimiter symbols or delimiter characters, and judges whether the above-mentioned extracted data is compatible with the above-mentioned table information stored in the above-mentioned table information storage process; and a database accumulation process that accumulates the above-mentioned data extracted in the above-mentioned data compatibility process in accordance with the above-mentioned table information when the above-mentioned data is judged to be compatible with the above-mentioned table information in the above-mentioned data compatibility judgement process.

By further equipping the data management method of the present invention with the above database accumulation process, the operator of a user terminal can easily build a database in a remote server. The operator of a user terminal can also easily update and change a database by sending a data file that includes either all the data after it has been updated or modified or just the data that is to be modified.

In the data management method of the present invention, the server may further comprise a reading file generation process that generates reading files from which the data that makes up the above database can be read via a communication network. This enables easy provision of a link between a database and a web page and enables the data that makes up a database to be read via the Internet etc.

In the data management method of the present invention, the server may further comprises: a readable data judgement process that judges, for each above-mentioned item name, whether data corresponding to an item name should be rendered readable; a second table information storage process that stores information relating to judgement as table information in association with the item name; and a reading file generation process that generates a reading file which allows the item name that has been judged as a readable item name and data corresponding to this item name to be read through a communication network. With this constitution, it is enabled to control the access permissions through the Internet or the like, for respective data items constituting the database.

In the data management method of the present invention, the server may further comprise: a file creation process in which the above server creates files that include data that makes up the above database and that can be read; and a sending process for sending the above files. This enables a user terminal to obtain a file containing the latest data to be accumulated in a database.

In the data management method of the present invention, the server may further comprise a search and reading file generation process that extracts data including key data and data associated with that data from data that makes up a database, and that generates a reading file that has a search function for displaying the above extracted data so that the data can be read via a communication network. This enables a link between a database and a web page to be easily provided and enables a user to search for and read via the Internet data that makes up a database.

In the data management method of the present invention, the server may further comprise: a searchable data judgement process that judges, for each data item, whether or not data corresponding to that data item can be targeted by a search; a third table information storage process that links information relating to the judgement to the item name and stores it as table information; and a search and reading file generation process that extracts data including key data and data relating to that data from data corresponding to an item name that has been deemed to be searchable, and that generates a reading file having a search function for displaying the data extracted above so that the data can be read via a communication network. This enables the access rights to data that makes up a database to be controlled via the Internet etc.

The above reading file access rights can also be controlled in the data management method of the present invention. This enables control of who is allowed what degree of access to data. Therefore, it is possible to allow only prescribed users to read, update, or delete reading files via the Internet etc.

In the data management system according to the present invention, a server, that can communicate via a communication network with a user terminal that has a Web browser, comprises: a reception portion that receives table files having data required for defining at least item names and data types corresponding to the above-mentioned item names; a table file judgement portion that judges whether or not the above-mentioned table file received is a table text file in text format in which the above-mentioned data is delimited by delimiter symbols or delimiter characters therein; a table file conversion portion that converts into table text files table files which have been judged not to be the above-mentioned table text files in the above-mentioned table file judgement part; a table information determination portion that extracts, in accordance with the above-mentioned delimiter symbols or delimiter characters, data required for defining at least item names and data corresponding to the above-mentioned item names from the above-mentioned table text file and that determines table information including at least item names and data types corresponding to the above-mentioned item names; and a table information storage portion that stores the above-mentioned table information in association with at least item names and data types corresponding to the above-mentioned item names.

By receiving prescribed table files from a user terminal, the above data management system of the present invention enables the provision of a system that allows easy definition of tables required for building a database.

In the data management system of the present invention, the above server may further comprise: a data file judgement portion that judges whether or not said table text file is a data text file that contains data to be accumulated in database and is in text format in which data is delimited by delimiter symbols or delimiter characters therein; and a database accumulation portion that, when said data file is judged to be said data text file in said data file judgement part, extracts said data to be accumulated in data base which is stored in said data text file in accordance with said delimiter symbols or delimiter characters, and that accumulates said data in accordance with said table information stored in said table information storage portion.

Also in the data management system, the above server may further comprise: a second reception portion that receives data file including data to be accumulated in database from user terminal via communication network; a second data file judgement portion that judges whether or not the above-mentioned received data file is a data text file in text format in which data is delimited by delimiter symbols or delimiter characters therein; a data file conversion portion that converts the above-mentioned data file into data text file when the above-mentioned data file is judged not to be the above-mentioned data text file in the above-mentioned second data file judgement part; a data compatibility judgement part that extracts the above-mentioned data to be accumulated in database, which is stored in the above-mentioned data text file, in accordance with the above-mentioned delimiter symbols or delimiter characters, and that judges whether or not the above-mentioned extracted data is compatible with the above-mentioned table information stored in the above-mentioned table information storage portion; and a database accumulation portion that, when data is judged to be compatible with the above-mentioned table information in the above-mentioned data compatibility judgement portion, accumulates the above-mentioned data extracted by the above-mentioned data compatibility judgement portion in accordance with the above-mentioned table information.

This enables the provision of a system that enables the easy creation, update, or modification of a database by receiving prescribed files from a user terminal.

In the data management system of the present invention, the above server may further comprise a reading file generation part that generates, via the Internet etc., in which data in the above database can be read. This enables the simple provision of a link between a database and a web page and enables data that makes up a database to be read via the Internet etc.

In the data management system of the present invention, the above server may further comprise: a reading data judgement portion that judges, for each the above-mentioned item name, whether or not data corresponding to the above-mentioned item name should be rendered readable via a communication network; a second table information storage portion that stores, as table information, information relating to judgement in association with the above-mentioned item name; and a reading file generation portion that generates a reading file in which item names judged to be readable item names and data corresponding to the above-mentioned item names can be read via a communication network. This enables access rights to all the data that makes up a database to be controlled via the Internet etc.

Also, in the data management system of the present invention, the server may further comprise: a file creation portion that creates a file that includes data that makes up the above-mentioned database and is judged to be readable; and a sending portion that sends the above-mentioned file. This enables a user terminal to obtain files that include the latest data to be accumulated in a database.

In the data management system of the present invention, the server may further comprise: a reading file generation portion that extracts data including key data and data associated with that data, from data that makes up the above-mentioned database, and that generates a search and reading file having a search function for displaying the above-mentioned extracted data so that the data can be read via a communication network.

Also, in the data management system of the present invention, a server may further comprise: a searchable data judgement portion that judges, for each item name, whether or not data corresponding to the above-mentioned item name should be rendered searchable; a third table information storage portion that stores, as table information, information relating to judgement in association with the above-mentioned item name; and a search and reading file generation portion that extracts, from data corresponding to item names that can be rendered searchable, data including key data and data associated with that data, and that generates a reading file having a search function for displaying the above-mentioned extracted data so that the data can be read via a communication network.

Access rights to the above reading files can also be controlled in the data management system of the present invention. This enables control of who will be allowed what degree of access to files. Therefore, it is possible to permit only prescribed users to read, update, and delete reading files via the Internet etc.

Also, the programs associated with the present invention executes the above data management method of the present invention on a computer.

### BRIEF DESCRIPTION OF THE DRAWINGS

FIG. 1 shows the hardware configuration used in a first aspect of the embodiment of the present invention;

FIG. 2 shows the configuration of a server system in a first aspect of the embodiment;

FIG. 3 is a flowchart showing the operations involved in a first aspect of the embodiment;

FIG. 4 is a flowchart showing the operations involved in a first aspect of the embodiment;

FIG. 5 is a flowchart showing the operations involved in a first aspect of the embodiment;

FIG. 6 shows the configuration of a file information input screen in the present invention;

FIG. 7 shows an example of the configuration of a table information contents confirmation screen in the present invention;

FIG. 8 shows an example of the configuration of a screen for confirming the existence of a display of database contents in the present invention;

FIG. 9 shows an example of the configuration of a screen that displays the contents of the database in the present invention;

FIG. 10 shows an example of the configuration of a reading file screen that displays the contents of the database in the present invention;

FIG. 11 shows an example of the configuration of a reading file screen that displays the results of a search made of the contents of the database in the present invention;

FIG. 12 shows an example of the configuration of a information input screen for a database to be updated in the present invention;

FIG. 13 shows an example of the configuration of a data file information input screen in the present invention;

FIG. 14 shows an example of the configuration of a screen that displays the contents of a database after it has been updated in the present invention;

FIG. 15 shows an example of the configuration of a screen that displays the contents of a database after it has been updated in the present invention;

FIG. 16 shows part of the configuration of a screen for confirming the existence of updates for each piece of data in the present invention; and

FIG. 17 shows an example of the configuration of an input screen for update contents in the present invention.

### DESCRIPTION OF THE PREFERRED EMBODIMENTS

A preferable aspect of the embodiment of the present invention will be explained below with reference to the appended figures. To simplify the understanding of the explanation, as far as possible the same reference numbers have been used to show the same configuration elements in all figures and duplicate explanations are omitted.

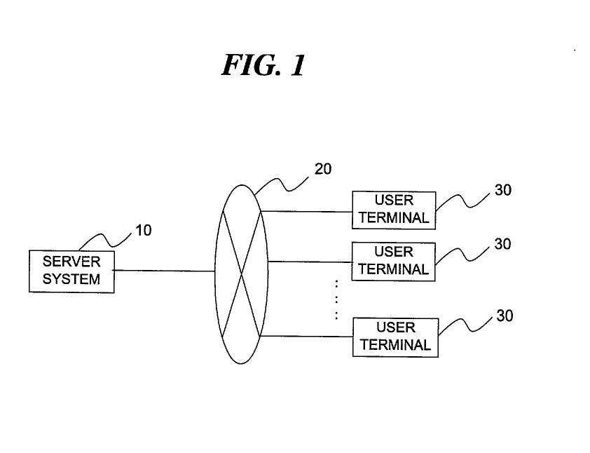

FIG. 1 shows the hardware configuration used in an aspect of the embodiment of the present invention. The server system 10 and user terminal 30 can communicate with each other via a communication network 20 such as the Internet or a LAN. In this description, the communication network 20 can also refer to a wireless network. The server system 10 comprises a Web server, database server, and all necessary peripheral equipment. These may be the same server. Examples of server system 10 include for example, a rental server system, the server system of an Internet provider, or a server system installed in a company or school. The server system 10 can be installed in the same building that houses the user terminal 30 or in another building.

The user terminal 30 has a display part, for example a CRT or LCD, and an input part, for example a keyboard or a mouse. There may be a multiplicity of user terminals 30, as in the pictured example, or there may be a single terminal. The user terminal 30 may also be a client terminal that has been provided with an ID and password by the server system 10.

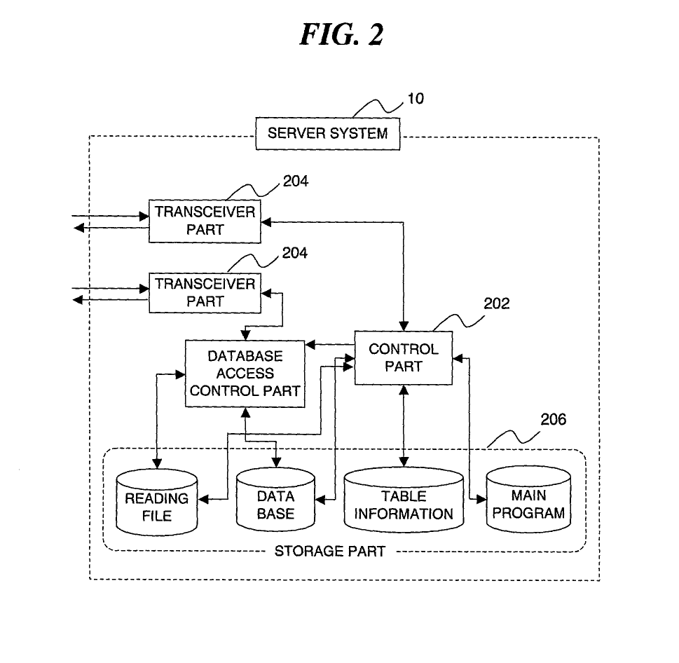

FIG. 2 shows the configuration of the server system 10. The server system comprises a control part 202, transceiver part 204, and storage part 206. Each part may be placed in a single server, or in one or all of a multiplicity of servers. The control part 202 comprises of a CPU. It controls each part, transmits data, implements various calculations, temporarily stores data, generates all types of files including reading files, judges, converts and processes files and data, and generates an access control part for controlling access to a database after it is built. The transceiver part 204 receives web page read requests and files sent from the user terminal 30 via a communication network 20, and sends these to the control part 202 and database access control part. It also receives responses to web page read requests sent from the control part 202 or the database access control part and sends these to the user terminal 30 via the communication network 20.

The main program is stored in the storage part 206. This main program is used in the control part 202. Also, in the present invention, table information, databases, and generated reading files are stored in the storage part 206. The storage part 206 may be installed in a server or may be installed as an external storage device that is connected to a server.

Next, the data management method that uses such a data management system in the present invention will be explained while referring to the examples in the figures.

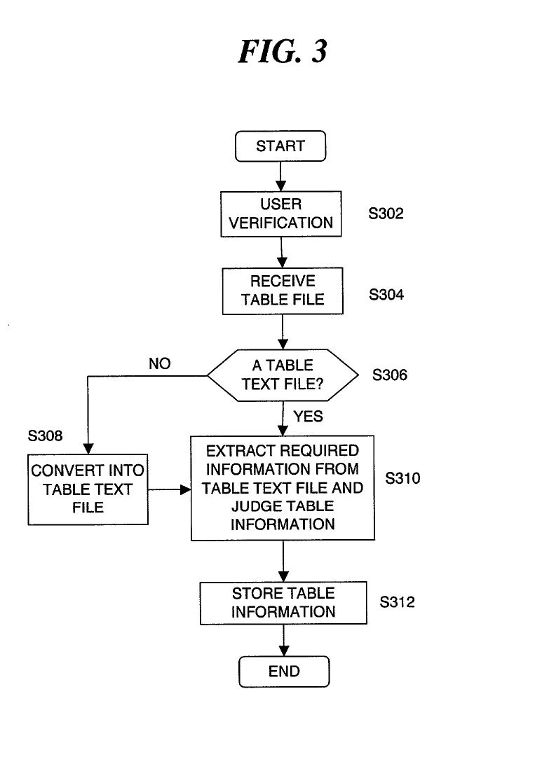

FIG. 3 is a flowchart that shows the series of program operations involved up to the storage of table information by a server that received table files from the user terminal.

In FIG. 3, the server that makes up the server system 10 is ready to communicate via a communication network with a user terminal 30 that has a Web browser. When the user terminal 30 has been given an ID and password by the server, the server implements user verification to determine, according to the ID and password sent by the user terminal 30, whether the ID and password received are registered for the user terminal 30 (S302). Here, the user involved must someone (database manager) who has been given the rights, by the server manager, to store table information for building databases on the server. User verification can be done on a screen displayed on the display part of the user terminal 30 using a Web browser. When the communication network is a local network and there is no particular need for user verification, this user verification process can be omitted.

Next, the server receives a table file via a communication network. This table file contains data including item names and is sent by the user terminal 30 (reception process: S304).

The above table files contains the data needed to define at least item names and data types corresponding to those item names. The above table files can be in text format or in binary format. They may also include image data such as picture or music data. The above table files contain a multiplicity of data, including item names, and data is delimited by delimiter symbols or delimiter characters. The files can store databased on prescribed rules or can be created by general purpose table creation software. The above rules for storing data can, for example, match the rules used when the server extracts the information required form a table file. For example, the rule could state that the data type or the order of data is determined for each line or for each column in a table file.

In this description, commas, tabs, spaces, returns, and specific codes are examples of delimiter codes or delimiter characters that can be used.

Next, the server judges whether or not the received table file is a prescribed table text file (table file judgement process: S306). Here, a table text file refers to a file in text format, data being delimited by delimiter symbols or delimiter characters therein. It is a file in which data is stored based on prescribed rules. The above rules for storing data can, for example, match the rules used when the server extracts the information required form a table file. For example, the rule could state that the data type or the order of data is determined for each line or for each column in a table file.

Table 1 is a conceptual diagram of an example of a table text file. n item names delimited with tabs are stored in the first line of the table text file. m pieces of data corresponding to each item name are stored for those item names in the second line and thereafter.

TABLE 1

| Item name 1 | Item name 2 | . . . | Item name n |
|---|---|---|---|
| Data 1-1 | Data 2-1 | . . . | Data n-1 |
| . | . | | . |
| . | . | . . . | . |
| . | . | | . |
| Data 1-m | Data 2-m | | Data n-m |

The server converts into a table text file any file not judged within the above table file judgement process to be a table text file (table file conversion process: S308).

Next, the server extracts the information required to define tables from a file judged by the above table file judgement process to be a table text file or from a file converted into a table text file by the table file conversion process. That is, it extracts the data required to define at least item names and data types corresponding to item names. Here, data is extracted in accordance with the delimiter symbols or delimiter characters that delimit pieces of data in a table text file. Data is extracted, for example, by extracting all item names and at least one piece of data corresponding to each item name. For example, of the table text files shown in Table 1, all of the first line (item names 1 through n) and at least all of the second line (data 1-1 through data n-1) are extracted. By perusing at least one piece of data corresponding to each item name, the data type that corresponds to each item can be judged in the table information determination process described below. From the viewpoint of improving the precision of table definition, it is preferable that a multiplicity of data corresponding to each data item be extracted. All data may be extracted.

The server judges the table information from the extracted information (table information determination process: S310). For example, it judges whether or not extracted information is an item name, a number, or a letter and, as required, determines the length of letters, that is whether or not they are of variable length, fixed length, maximum length, or minimum length, and the character code type, or number type, that is whether or not they are ordinary integer, monetary amount, or whether they are floating decimal. The length of characters or numbers can be determined from the data or can be preset.

Next, the judged table information is stored after it is linked to information relating to at least each item name and all data corresponding to those item names (table information storage process: S312). The minimum table information to be stored is each item name and the data types corresponding to those item names. Other table information, for example the size of the data, can also be stored. The server can also store this information as a multiplicity of table information based on factors such as the character of each piece of data, its importance, duplicity, and access or update frequency. For example, item names and data types corresponding to those data names could be stored in one lot of table information. Information relating to data reading and searching and data and file access rights, discussed later, can be stored as separate table information.

Table 2 is a conceptual diagram of an example of table information stored based on the table text file shown in Table 1. As shown in Table 2, item names 1 through n are stored as item names (names) and data types corresponding to those item names (text, int) are stored after being linked to those item names.

TABLE 2

| name | type |
|---|---|
| Item name 1 | text |
| Item name 2 | text |
| . | . |
| . | . |
| . | . |
| Item name n | int |

To heighten stability of stored table information, access rights settings for the table information itself can be included in the table information. Such information could include settings relating to who has rights to add new information to table information, rights to read table information, rights to update table information, rights to set access rights on the table information, and rights to delete entire the table information.

In addition, to make table information stored in a server more accurate, the server can display the table information defined in the above process on the display part of the user terminal 30 for user confirmation. This confirmation can be done using a Web browser through a screen displayed on the display part of the user terminal 30 and the user can be prompted to enter any changes to the table information. The server stores the changed table information after receiving it.

Thus, the user can use the present invention to automatically define any tables required for database creation in a remote server simply by sending table files that include the prescribed information.

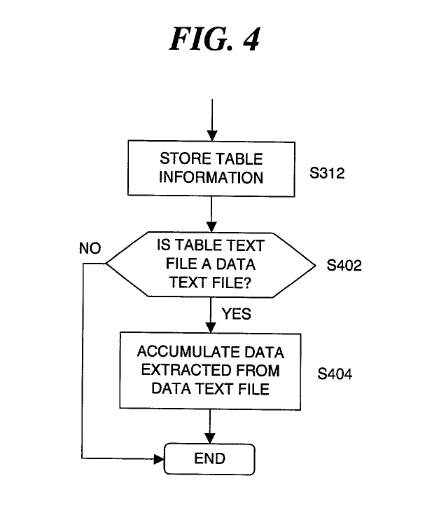

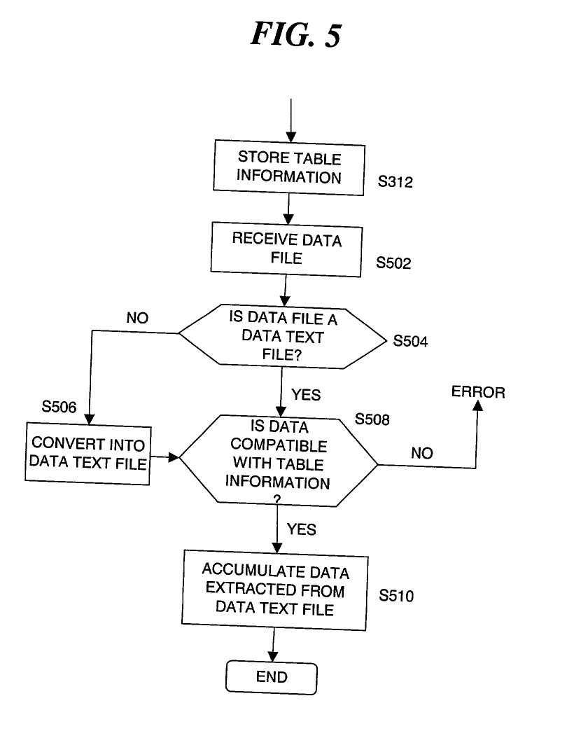

In the present invention the server can further accumulate data for databases using the above table information. Databases data accumulation can be done by accumulating data stored in the above table text file (FIG. 4) or by accumulating data stored in data files received separately from a user terminal (FIG. 5).

FIG. 4 is a flowchart that shows the program operations involved in database accumulation in which data stored in table text files is accumulated in accordance with table information.

In FIG. 4, the server firstly judges whether or not a table text file is a prescribed data text file (data file judgement process: S402).

Here, a data text file refers to a file in text format that includes data to be accumulated in database and in which the above data is delimited by delimiter symbols or delimiter characters. A data text file is a file in which data is stored based on prescribed rules. The above rules for storing data can, for example, match the rules used when the server extracts the information required form a table file. For example, the rule could state that the data type or the order of data is determined for each line or for each column in a table file.

Here, the user that sent the table file to the server must be a database manager and, at the same time, must be the person allocated rights by the server manager or database manager (table manager) to be able to accumulate database data. Therefore, a user verification process can also be installed prior to the data file judgement process.

Next, the server extracts, in accordance with the above delimiter symbols or delimiter characters, the above data to be accumulated in a database from a file deemed to be a data text file in the above data file judgement process. It then accumulates the above data in accordance with the table information stored in the server and thus builds a database (database accumulation process: S404). Widely known methods can be used for the storing of data in accordance with table information.

FIG. 5 is another flowchart that shows program operations involved in database accumulation using data stored in data files received from a user terminal.

In FIG. 5, the server firstly receives, via a communication network, data files containing data to be accumulated in a database and that have been sent by a user terminal 30 (second reception process: S502). Here, the user must be a person (table manager) who has been allocated the rights to be able to accumulate database data by the server manager or database manager. Therefore, a user verification process can also be set up prior to the reception process.

Here, the above data file contains at least item names and data to be accumulated in a database that corresponds to these item names. The above data file can be in text format or in binary format. It may also include image data such as picture data or music data. The above data file contains a multiplicity of data including item names, and each data is delimited by delimiter symbols or delimiter characters. The file may be one in which data are stored based on prescribed rules or may be one created by general purpose table creation software. The above rules for storing data can, for example, match the rules used when the server extracts the information required form a table file. For example, the rule could state that the data type or the order of data are determined for each line or for each column in a table file.

Next, it is judged whether or not the data file is a prescribed data text file (second data file judgement process: S504). The explanation about data text files is the same as that provided for FIG. 4.

The server converts into a data text file any file judged not to be a data text file in the above second data file judgement process (data file conversion process: S506).

Next, the server extracts, in accordance with the above delimiter symbols or delimiter characters the above data to be accumulated in database from a file judged to be a data text file in the above second data file judgement process or from a file converted into a data text file in the conversion process. It then judges whether or not the data extracted above is compatible with the table information stored in the server (data compatibility judgement process: S508). Processing ends in an error if the data is judged to be incompatible.

On the other hand, if the data are judged to be compatible with table information in the above data compatibility judgement process, the above data extracted in the above process are accumulated in accordance with the above table information and a database is built (database accumulation process: S510). Well known methods can be used to accumulate data in accordance with table information.

In the present invention, data that makes up a built database can generate readable files (hereinafter referred to as reading files) (reading file generation process). A reading file refers to a file that can be read via a communication network using a so-called Web browser. For example, it may be a file that is displayed as a web page.

Data that can be read can be judged when generating this type of reading file (reading data judgement process). This can be done independently by the server or by the server after it receives results of a user selection made in response to the display of a screen on the display part of the user terminal 30 asking the user to select data. Here, the user can be prompted to enter selection information on a screen displayed on the display part of the user terminal 30 using a Web browser. It is preferable that judgements relating to data are made for each item name. The results as judged by the server are linked to each item name, stored as table information in the server (second table information storage process), and used when a reading file is generated.

Also, in the present invention, the server can extract data containing key data and data linked to this data from data that makes up the above database, then generate a reading file with a search function that displays the above extracted data so that it can be read via a communication network (search and read file generation process).

Here, data to be targeted by searches can be judged from all the data that makes up a database (searchable data judgement process). This judgement work can be done independently by the server or by the server after it receives results of a user selection made in response to the display of a screen on the display part of the user terminal 30 asking the user to select data. Here, the user can be prompted to enter selection information on a screen displayed on the display part of the user terminal 30 using a Web browser. It is preferable that judgements relating to data are made for each item name. The results as judged by the server are linked to each item name, stored as table information in the server (third table information storage process), and used when a reading file is generated.

Data that can be read can also be judged when generating reading files that contain a search function. This judgement work can be done by the server independently or by the server after it receives results of a user selection made in response to the display of a screen on the display part of the user terminal 30 asking the user to select data. Here, the user can be prompted to enter selection information on a screen displayed on the display part of the user terminal 30 using a Web browser. It is preferable that judgements relating to data are made for each item name. The results as judged by the server are linked to each item name, stored as table information in the server, and used when a reading file is generated.

In the present invention, a reading file is generated, for example, as shown below. Firstly, the server receives a reading file generation request from the user terminal and generates a temporary file. Next, as required, it judges for each item name whether or not the data that makes up a database can be read and targeted by a search in accordance with table information. A program that extracts data from a database is then inserted in the file for data judged to be readable and a program that executes searches is inserted in the file for data judged to be searchable. A reading file is then generated.

In the present invention, the server can also create files that contain data that make up a database and which are deemed to be readable (file creation process). The server can send these files to a user terminal (sending process). Here, the above files may be in text format or binary format. In the above files, each data can be delimited by delimiter symbols or delimiter characters as is in a csv format file or may be a file in which data is stored based on prescribed rules. The file may also be a file such as an excel file, created using general purpose table creation software. The above rules for storing data can, for example, match the rules used when the server extracts the information required from a table file.

In the present invention, the server can also create a file that includes the results of a search made using a reading file with a search function. It can send this file to a user terminal. An example of such a file is the one explained in the above file creation process.

Access rights to the reading file explained above can be controlled when the reading file is generated in the server via a communication network in accordance with the request from a user terminal. That is, to what degree a user can access the reading file depending on his/her permission level can be controlled. This enables prescribed users to be able to revise and update generated reading files and prevents unnecessary leaking of reading files or duplication, corruption, or deletion of reading files by a third party.

An example of a method for allowing prescribed users prescribed access rights to reading files is a method in which reading files are created not according to server's rights stored by the reading file but by the above user's rights.

Reading file access rights like this can be controlled, for example, by the following process. Firstly, the server receives a request from a user terminal to generate a reading file. It then generates a temporary file in accordance with the reading file generation method described above. Next, the server specifies prescribed users including the person that requested the reading file generation. To match the person that generates the reading file and the above user, the temporary file is stored in a location to which the above user has prescribed rights (for example reading rights, writing rights, or deletion rights). In this way, the reading file can be placed under the prescribed rights for the prescribed user in this location. The person who requests generation of the reading file can also specify prescribed users as appropriate.

A prescribed user who is permitted to revise or update files can freely revise or update a reading file. For example, they can insert other images such as logos, change the lineup of displayed data, or add colour. This enables customization of a display screen.

Another method for controlling access rights to reading files is a method in which a part that controls access is embedded into the generated reading file.

As explained above, in the present invention, by simply sending a prescribed table file via a communication network, a user can automatically define tables required in the building of a database in a server located apart from the user terminal. This means that databases can easily be created in a server that is located away from a user terminal. Also, the user can update and change a database easily by sending data files containing all data after the update or modification or containing the data that has been changed. When required, the content of the table information can also be rewritten.

The present invention can also be used to link via a communication network databases built in a server and web pages generated by a server. Therefore, data that makes up a database can be read via a communication network and a search of data that makes up a database can be made for desired data.

The present invention also enables data that can be read or targeted by a search to be controlled when a database and web page are linked.

The present invention also enables prescribed access rights to reading files to be given only to prescribed users.

An example in which a database is built in accordance with the data management method that uses the data management system of the present invention is given below.

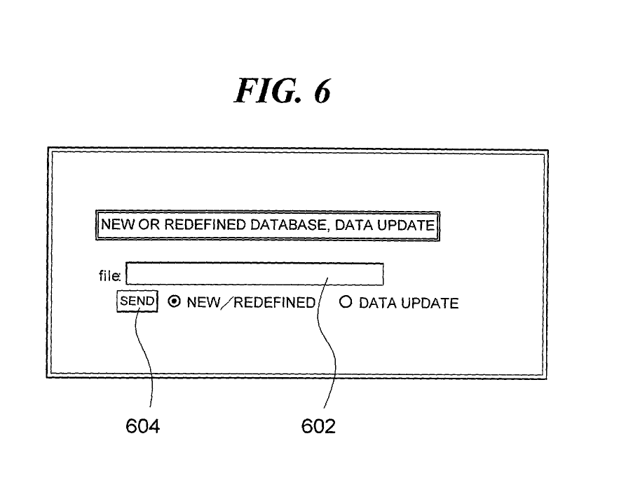

Firstly, after verifying a user, a server that can communicate with a user terminal 30 via a communication network uses a Web browser on the user terminal 30 to display the screen shown in FIG. 6 on the display part of the user terminal 30. This screen prompts the user to send the location of the table file to be sent, enter its name, and send the file. The user has the contents shown in Table 3. The user enters the location and name of a table file in the empty space 602 in which data is delimited by tabs and presses the “Send” button 604 to send the table file to the server.

TABLE 3

| No. | Product name | Description | Price |
|---|---|---|---|
| S2300 | Fish paste | Sendai specialty made | 2300 |
| | assortment | from the freshest fish | |
| F1000 | Fish set | Fresh fish of the day | 1000 |
| F5 | New season | A new variety of rice from | 5000 |
| | Manamusume rice | Miyagi Prefecture.-Manamusume | |
| BB4000 | New season | Chemical-free health rice. | 4000 |
| | Sasanishiki rice | A Miyagi Prefecture specialty | |
| SH6000 | Young sake | A product of Miyagi Prefecture | 6000 |

The server that received the above table file confirms that it is a table text file, extracts the first line from the file, and determines the item names and number of item names from the delimiters entered as tabs. Next, the server extracts the second line of the table text file and judges the data types for each item name. It then links this information to item names and stores it as table information. The contents of the table information thus stored in the server are shown in Table 4.

TABLE 4

| name | type |
|---|---|
| No. | text |
| Product name | text |
| Description | text |
| Price | int |

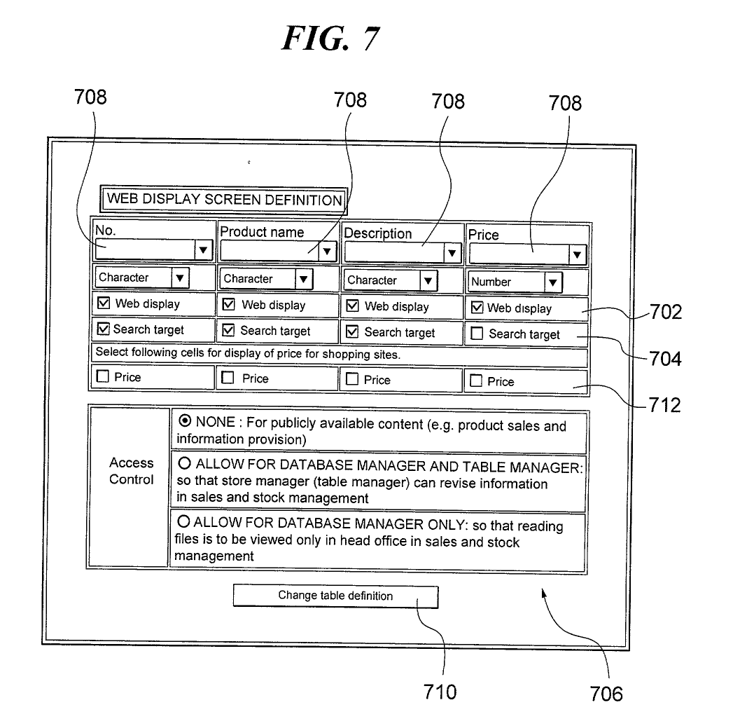

Next, the server shows the contents of the table information on the display part of the user terminal 30 and displays a screen, as shown in FIG. 7, that prompts the user to enter any changes to the table information. At this time, when a reading file is to be generated, a screen 702 is displayed that asks, for each item, if all data should be readable or a screen 704 that asks if all data should be searchable, and a screen 706 that asks how access rights to reading files should be controlled.

When there are changes to the table information, the user enters or selects those changes in each empty space 708. Alternatively, the user enters or selects whether or not data is readable or whether or not data is searchable for each item name and then presses the “Change table definition” button 710. The changed contents are then sent to the server. As shown in the example pictured, when a reading file is used as a shopping site, it is also possible to request selection of an item in which the price is described (cell 712). When changes to table information are sent from the user terminal, the server stores those changes as table information. In this way, the updated table information contents are shown in Table 5.

TABLE 5

| name | type | web | search | price |
|---|---|---|---|---|
| No. | text | 1 | 1 | 0 |
| Product name | text | 1 | 1 | 0 |
| Description | text | 1 | 1 | 0 |
| Price | int | 1 | 0 | 0 |

| | |
|---|---|
| Access control | 0 |

In Table 5, “1” in the “web” item means “make readable” and “0” means “do not make readable”. Likewise, “1” in the “search” item means “make searchable” and “0” means “do not make searchable”. When the reading file is to be used as a shopping site, “0” in the “price” item means “the price will not be provided” and “1” means “the price will be provided”. Also, “0” in the “access control” item means that the reading file itself is “readable by all”.

The server confirms that the table text file is a data text file then, in accordance with the table information, sequentially extracts and accumulates data stored in the table text file to create a database. Here, the database is created in accordance with the newest table information.

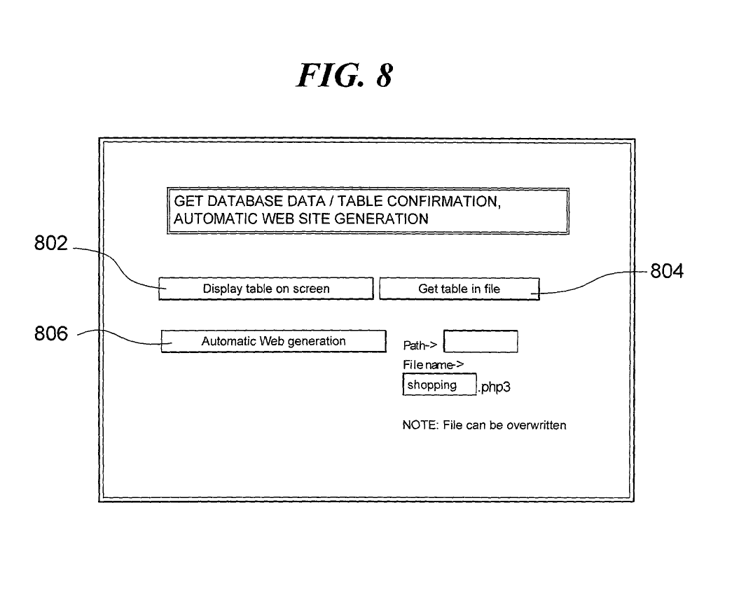

The server then displays a screen, such as that shown in FIG. 8, that asks whether or not readable data in the database is to be displayed, whether or not a file that stores readable data should be created, or whether or not a file from which readable data can be read via a communication network should be created.

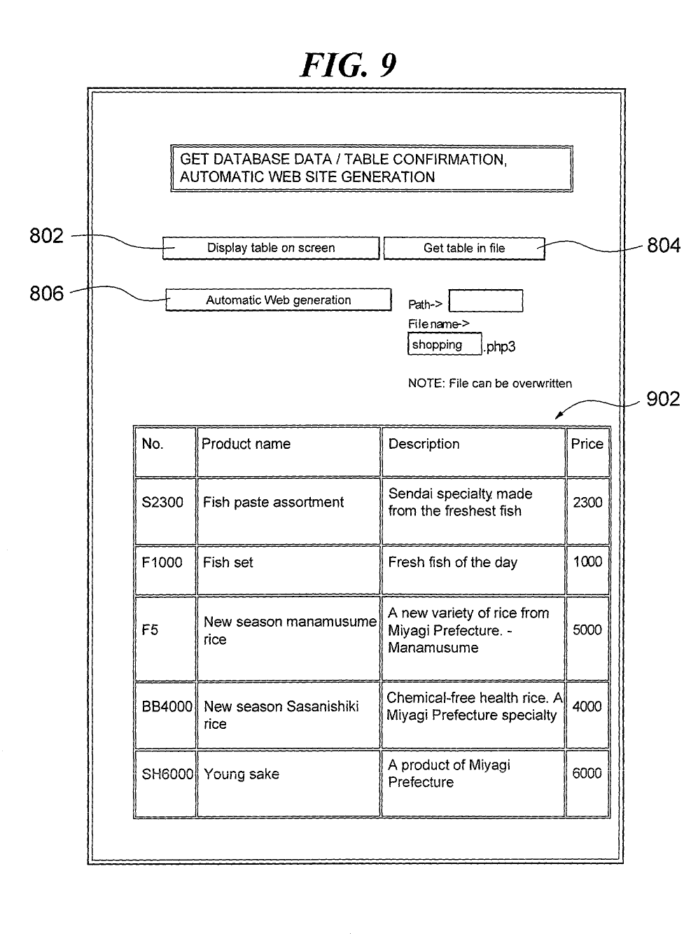

When the user selects “Display table on screen” (802) and sends this request to the server, the server displays a screen 902, such as that shown in FIG. 9, that shows the readable data in a database on the display part of the user terminal 30. This enables the user to confirm the contents of the database.

Also, when the user selects “Get table in file” (804) and sends this request to the server, the server will create a file in which the readable data from a database is stored and send this to the user terminal.

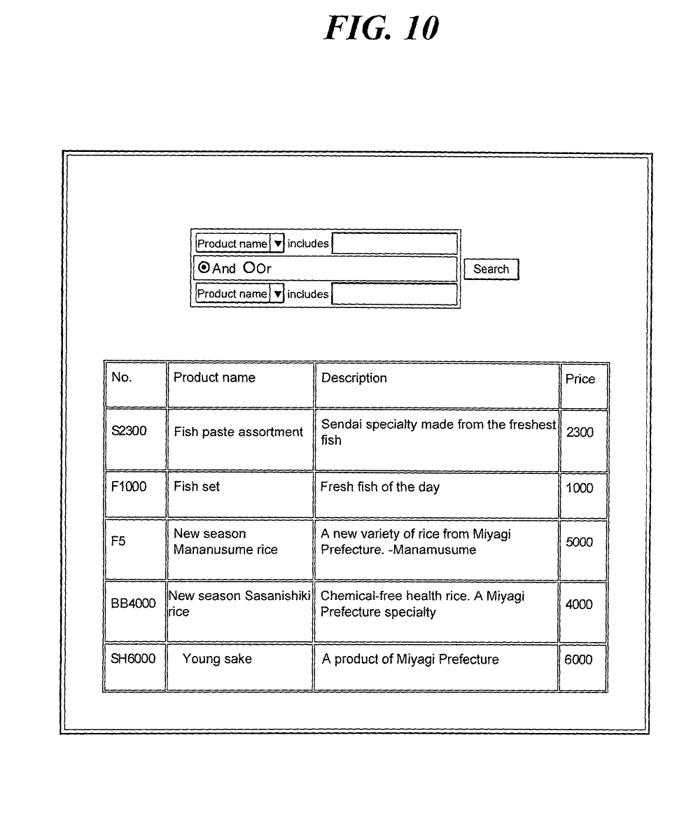

When a user selects “Automatic Web generation” (806) and sends this request to the server, the server will generate a reading file, that enable the data judged readable via a communication network in accordance with table information. The server will then generate a reading file in which the relevant can be searched via a communication network. When the reading file is to be used as a shopping site, the server will generate a reading file for items for which the price will be displayed that is linked to the settlement Web page of that shopping site. When required, access rights to the reading files can be controlled so that they are specified by the user in FIG. 7, and a screen that has a search function as shown in FIG. 10 is displayed on the display part of the terminal 30.

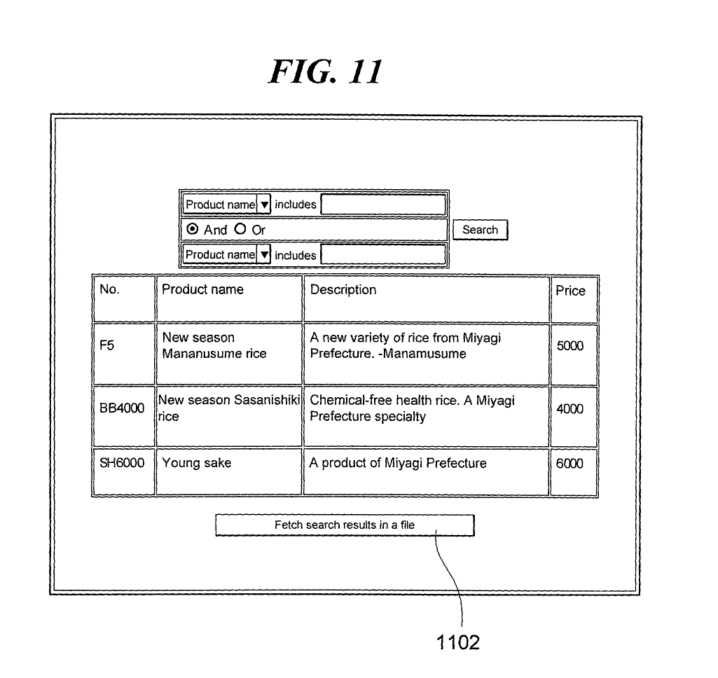

A search is made for data that corresponds to item name “Product name” and includes “Rice”, and for data that corresponds to “Description” and includes “Miyagi”. FIG. 11 displays the results of these searches and data that is linked to this type of data. Thus, the present invention can be used to easily link a database and a web page.

As shown in FIG. 11, the server can display a display part that asks whether or not to create a file into which search results are stored on a search results screen as above. When the user selects “Fetch search results in a file” (1102) and sends this request to the server, the server creates a file to store search results and sends this to the user terminal 30.

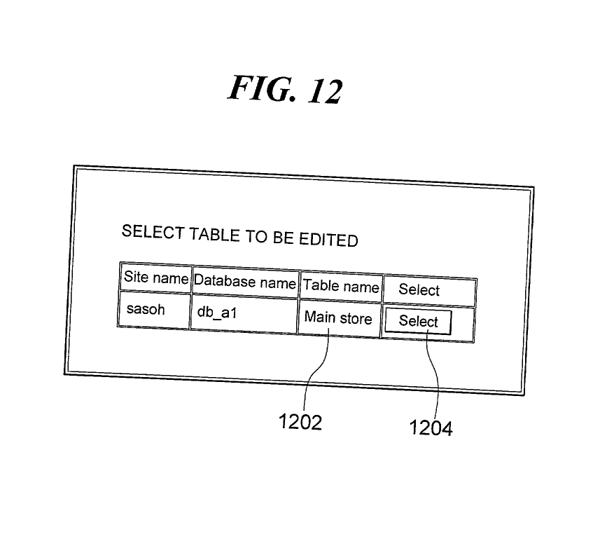

When a user with table manager rights updates all or part of a database, the server first uses the Web browser on the user terminal 30 to display, on the display part of the user terminal 30, a screen such as that shown in FIG. 12 that asks which table information for what database should be updated. The user selects the table information 1202 in which data is to be updated and presses the “Select” button 1204.

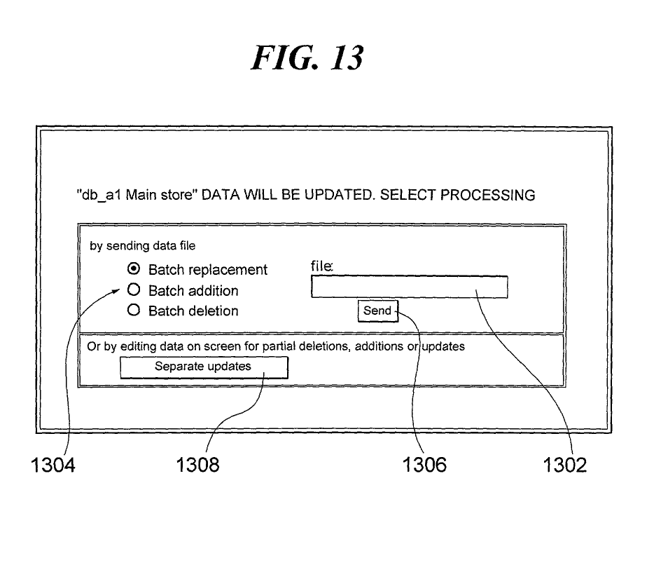

Next, the server uses the Web browser on the user terminal 30 to display, on the display part of the user terminal 30, a screen such as that shown in FIG. 13 that prompts the user to enter the location and name of the data file to be sent and to send the file. The user has the contents shown in Table 6 and enters the location and name of the data file in the empty space 1302 in which data is delimited using tabs. The user also selects the type of update desired (1304), presses the “Send” button 1306 and sends the file to the server.

TABLE 6

| No. | Product name | Description | Price |
|---|---|---|---|
| T2000 | Rice cakes | Rice cakes made with | 2000 |
| | | delicious Miyagi rice | |
| A8000 | Gourmet assortment | Famous Sendai assortment | 8000 |
| AP30000 | Recruit brand suit | 3-piece suit. A basic | 30000 |
| | | Recruit item | |

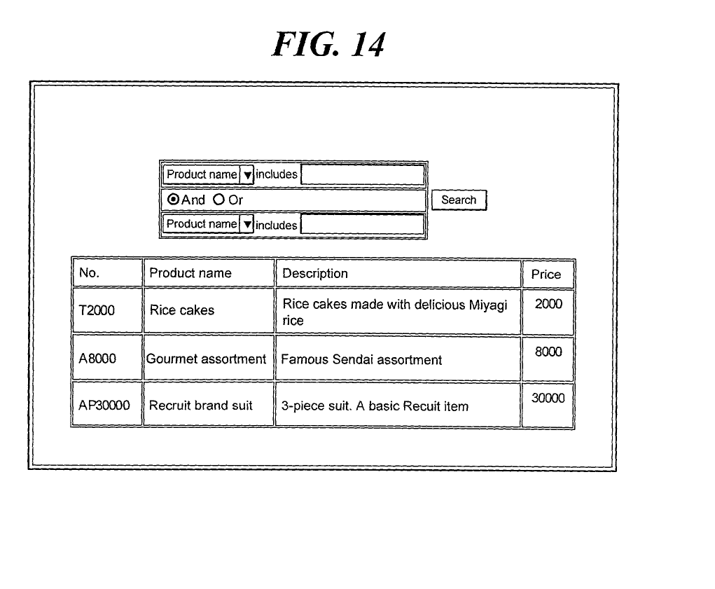

In FIG. 13, when the user selects “Batch switch”, the server that received the above data file confirms that it is a data text file and confirms that it is compatible with the table information specified by the user. It deletes all data from an existing database specified by the user then, in accordance with the above table information, sequentially extracts data stored in the received data text file and accumulates this in a database. A reading file created based on a database collated in this way is shown in FIG. 14.

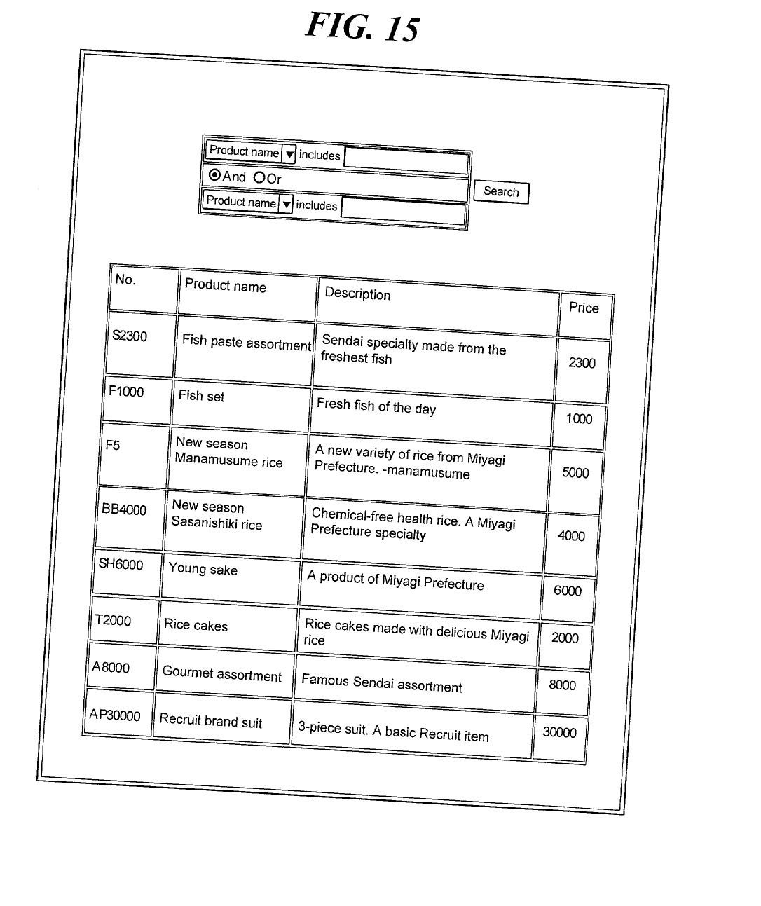

In FIG. 13, when the user selects “Batch addition”, the server that received the above file confirms that it is a data text file and confirms its compatibility with the table information specified by the user. Then, in accordance with the above table information, it then sequentially extracts data stored in the data text file and adds it to an existing database specified by the user. A reading file created based on a database collated in this way is shown in FIG. 15.

When the user selects “Batch deletion” and sends this request to the server, the server will delete all data in an existing database specified by the user.

By selecting “Separate updates” (1308) in FIG. 13, a user can update or delete all or part of a database in the server on the Web without sending any data files.

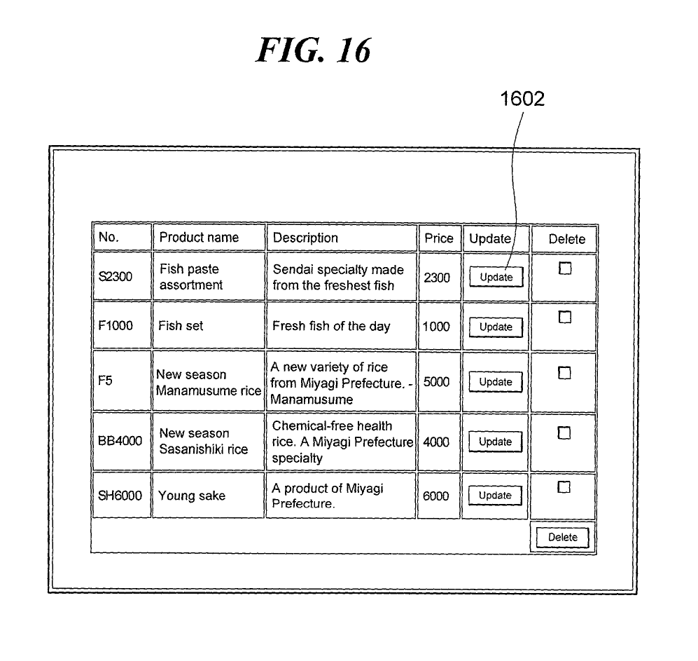

When the user selects “Separate updates” (1308) in FIG. 13 and sends this request to the server, the server uses the Web browser on the user terminal 30 to display, on the display part of the user terminal 30, a screen such as that shown in FIG. 16 that asks for the line in which data is to be updated or deleted. The user selects the line in which data is to be updated or deleted.

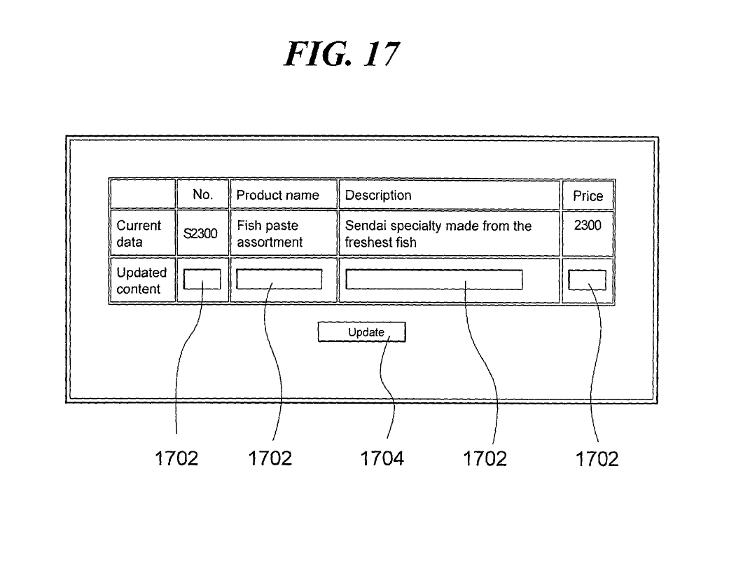

In FIG. 16, when the user selects “Update” (1602) for the line starting with “S2300”, the server uses the Web browser on the user terminal 30 to display, on the display part of the user terminal 30, a screen such as that shown in FIG. 17 that asks how which data in this line should be updated. The user inputs the new data in the empty space 1702 below the data to be updated then presses “Update” button 1704. The server that receives the updated information, updates the data in the database. By repeating this work as frequently as required, a database can be updated or deleted.

In the present invention, the tables needed to build a database in a computer that is situated away from the user terminal can be defined by sending a prescribed table file from a user terminal. In this computer, a server can build a new database in accordance with the defined table information. Also, a database built on this computer can be easily updated or modified by sending a prescribed file from the user terminal. It is also easy to link a database built in this way to a web page and access rights to web pages can be controlled.

What is claimed is:

1. A method for managing data in a server that can communicate via a communication network with a user terminal that has a Web browser, wherein said server comprises:
a reception process that receives table files containing data required for defining at least item names and data types corresponding to said item names from a user terminal via a communication network;
a table file judgement process that judges whether or not said received table file is a table text file in text format in which data is delimited with delimiter symbols or delimiter characters;
a table file conversion process that converts said table file into table text file when said table file is judged not to be said table text file in said table file judgement process;
table information determination process that extracts, from said table text file, data required for defining at least item names and data types corresponding to said item names in accordance with said delimiter symbols or delimiter characters, and that determines table information which include at least item names and data types corresponding to said item names; and
a table information storage process that stores said table information in association with at least item names and data types corresponding to said item names.

2. The data management method according to claim 1, wherein said server further comprises:
a data file judgement process that judges whether said table text file contains data to be accumulated in database and is a table text file in text format, in which said data is delimited with delimiter symbols or delimiter characters; and
a database accumulation process that, when said file is judged to be said data text file in said data file judgement process, extracts said data to be accumulated in database stored in said data text file in accordance with said delimiter symbols or delimiter characters, and accumulates the extracted data in the database in accordance with said table information stored in said table information storage process.

3. The data management method according to either claim 1 or 2, wherein said server further comprises:
a second reception process that receives a data file that contains data to be accumulated in database from a user terminal via a communication network;
a second data file judgement process that judges whether said data file received is a data text file in text format in which data delimited with delimiter symbols or delimiter characters;
a data file conversion process that converts said data file into data text file when said data file is judged not to be said data text file in said second data file judgement process;
a data compatibility judgement process that extracts said data to be accumulated in database stored in said data text file in accordance with said delimiter symbols or delimiter characters, and judges whether said extracted data is compatible with said table information stored in said table information storage process; and
a database accumulation process that accumulates said data extracted in said data compatibility process in accordance with said table information when said data is judged to be compatible with said table information in said data compatibility judgement process.

4. The data management method according to either claim 2 or 3, wherein said server further comprises a reading file generation process that generates a reading file in which data that makes up said database can be read via a communication network.

5. The data management method according to either claim 2 or 3, wherein said server further comprises:
a reading file judgement process that judges, for each said item name, whether data corresponding to said item name should be allowed to read via a communication network;
a second table information storage process that stores, as table information, information relating to judgement in association with said item name; and
a reading file generation process that generates a reading file in which item names judged to be allowed to read and data corresponding to said item names can be read via a communication network.

6. The data management method according to either claim 4 or 5, wherein said server further comprises:
a file creation process that creates a file containing data that makes up said database and has been allowed to read; and
a sending process that sends said file.

7. The data management method according to any one of claims 2 through 6, wherein said server further comprises a search and reading file generation process that extracts data containing key data and data linked to that data from data that makes up said database, and that generates a reading file having a search function for displaying said extracted data so that the data can be read via a communication network.

8. The data management method according to any one of claims 2 through 6, wherein the server further comprises:
a searchable data judgement process that judges, for each said item name, whether data corresponding to said item name should be rendered searchable;
a third table information storage process that stores information relating to determination as table information in association with said item name; and
a search and reading file generation process that extracts data that contains key data and data linked to that data from data corresponding to an item name which has been judged to be rendered searchable, and that generates a reading file having a search function for displaying said extracted data so that the data can be read via a communication network.

9. The data management method according to any of claims 4 through 8, wherein access rights to said reading file are controlled.

10. A data management system, wherein a server, that can communicate via a communication network with a user terminal that has a Web browser, comprises:
a reception portion that receives table files having data required for defining at least item names and data types corresponding to said item names;
a table file judgement portion that judges whether or not said table file received is a table text file in text format in which said data is delimited by delimiter symbols or delimiter characters therein;
a table file conversion portion that converts into table text files table files which have been judged not to be said table text files in said table file judgement part;
a table information determination portion that extracts, in accordance with said delimiter symbols or delimiter characters, data required for defining at least item names and data corresponding to said item names from said table text file and that determines table information including at least item names and data types corresponding to said item names; and
a table information storage portion that stores said table information in association with at least item names and data types corresponding to said item names.

11. The data management system according to claim 10, wherein said server further comprises:
a data file judgement portion that judges whether or not said table text file is a data text file that contains data to be accumulated in database and is in text format in which data is delimited by delimiter symbols or delimiter characters therein; and
a database accumulation portion that, when said data file is judged to be said data text file in said data file judgement part, extracts said data to be accumulated in data base which is stored in said data text file in accordance with said delimiter symbols or delimiter characters, and that sequentially accumulates said data in accordance with said table information stored in said table information storage portion.

12. The data management system according to either claim 10 or 11, wherein said server further comprises:
a second reception portion that receives data file including data to be accumulated in database from user terminal via communication network;
a second data file judgement portion that judges whether or not said received data file is a data text file in text format in which data is delimited by delimiter symbols or delimiter characters therein;
a data file conversion portion that converts said data file into data text file when said data file is judged not to be said data text file in said second data file judgement part;
a data compatibility judgement part that extracts said data to be accumulated in database, which is stored in said data text file, in accordance with said delimiter symbols or delimiter characters, and that judges whether or not said extracted data is compatible with said table information stored in said table information storage portion; and
a database accumulation portion that, when data is judged to be compatible with said table information in said data compatibility judgement portion, accumulates said data extracted by said data compatibility judgement portion in accordance with said table information.

13. The data management system according to either claim 11 or 12, wherein said server further comprises a reading file generation portion that generates a reading file in which data that makes up a database can be read via a communication network.

14. The data management system according to either claim 11 or 12, wherein said server further comprises:
a reading data judgement portion that judges, for each said item name, whether or not data corresponding to said item name should be rendered readable via a communication network;
a second table information storage portion that stores, as table information, information relating to judgement in association with said item name; and
a reading file generation portion that generates a reading file in which item names judged to be readable item names and data corresponding to said item names can be read via a communication network.

15. The data management system according to either claim 13 or 14, wherein said server further comprises:
a file creation portion that creates a file that includes data that makes up said database and is judged to be readable; and
a sending portion that sends said file.

16. The data management system according to any one of claims 11 through 15, wherein said server further comprises a search and reading file generation portion that extracts data including key data and data associated with that data, from data that makes up said database, and that generates a reading file having a search function for displaying said extracted data so that the data can be read via a communication network.

17. The data management system according to any one of claims 11 through 15, wherein said server further comprises:
a searchable data judgement portion that judges, for each item name, whether or not data corresponding to said item name should be rendered searchable;
a third table information storage portion that stores, as table information, information relating to judgement in association with said item name; and
a search and reading file generation portion that extracts, from data corresponding to item names that can be rendered searchable, data including key data and data associated with that data, and that generates a reading file having a search function for displaying said extracted data so that the data can be read via a communication network.

18. The data management system according to any one of claims 13 through 17, wherein access rights to said reading file are controlled.
